(19) United States
(12) Patent Application Publication
(10) Pub. No.: US 2026/0195196 A1
(43) Pub. Date: Jul. 9, 2026

(54) Method for managing a distributed architecture of data centres, and corresponding device and computer program

(71) Applicant: ORANGE, Issy-les-Moulineaux (FR)

(72) Inventors: Benoît LEMOINE, Châtillon (FR); Khaled SAYAD, Châtillon (FR)

(21) Appl. No.: 19/127,820

(22) PCT Filed: Nov. 6, 2023
(86) PCT No.: PCT/EP2023/080747

§ 371 Date: May 7, 2025

(30) Foreign Application Priority Data
Nov. 8, 2022 (FR) 2211626

(51) Int. Cl. G06F 9/50

(52) U.S. Cl. CPC G06F 9/5094; G06F 9/5077; G06F 2209/508

(57) ABSTRACT

A method for managing a distributed architecture of data centers hosting a plurality of servers within which virtualization nodes are intended to be deployed. In such a method, an item of management equipment of the distributed architecture: obtains data relating to a maintenance operation involving at least one first item of equipment of an electricity distribution network supplying a first data center of the distributed architecture with power, the data including at least one maintenance duration of the first item of equipment, and transmits, to an entity for the deployment of the virtualization nodes within the distributed architecture, a first list including at least one identifier of at least one second item of equipment of the electricity distribution network supplying the first data center with power, having a maintenance duration that is shorter than or equal to the autonomy duration of the first item of electrical equipment.

### FIELD OF THE INVENTION

The field of the invention is that of cloud computing.

More particularly, the present invention relates to the management and protection of computer servers hosted in data centres of a distributed architecture and within which virtualisation nodes are intended to be deployed, in order to protect the virtualised functions instantiated on these virtualisation nodes in the event of a failure of one or more items of equipment of an electricity distribution network supplying the data centres with power.

### PRIOR ART AND ITS DISADVANTAGES

For several years now, telecommunications networks have been using virtualised functions instantiated on virtualisation nodes hosted in virtual machines or in servers grouped into clusters within data centres, giving rise to cloud computing. In the remainder of the document, reference is made to virtualisation nodes hosted in servers, but it is understood that the lesson from the present document also applies to the case of virtualisation nodes hosted in virtual machines.

An example of virtualised function instantiation management is referred to as Kubernetes. A Kubernetes architecture comprises at least one cluster of virtualisation nodes. Such a cluster of virtualisation nodes comprises at least one first node, referred to as the “Kubernetes master node”, and a plurality of “Kubernetes worker nodes”, intended to instantiate virtualised functions.

The master node comprises, among other things, an ETCD database that consists of a dynamic configuration register of the worker nodes.

A worker node comprises a plurality of virtualisation units or “pods”. Each virtualisation unit is provided with resources for executing one or more tasks. When a task is executed, it contributes to the implementation of a service or a virtualised function.

The ETCD database embedded in the master node stores in reference files a list of virtualisation units to be instantiated as well as parameters to be taken into account when instantiating virtualised functions.

The master node regularly reads the content of these files, compares it with the virtualisation units being instantiated and adds or removes virtualisation units in order to adapt their quantity to that indicated in these reference files.

The ETCD database also being accessible by an entity for the deployment of the virtualisation nodes, the latter regularly reads the content of these files, compares the capacity of the deployed virtualisation nodes with the capacity required by the virtualisation units being instantiated and adds or removes virtualisation nodes in order to adjust their quantity to the needs.

The deployment of a virtualisation node on a computer server consists, for example, in downloading on a computer server a file containing an operating system and a set of applications needed to deploy the virtualisation node, and then starting the computer server using the downloaded file.

It is also possible to deploy several virtualisation nodes on the same computer server by using virtual machines. In this case, once the file has been downloaded on the computer server, a virtual machine is started using the downloaded file.

With a view to reducing operations costs and improving the flexibility of network infrastructures, cloud computing architectures are most often distributed or multi-site architectures in which the servers hosting the virtualisation nodes belonging to the same node cluster can be located on distinct and remote geographical sites.

Certain virtualised functions requiring low latency, for example, tend to be executed by virtualisation units deployed in servers located at the edge of communications networks, that is, as close as possible to the user terminals requiring a given service, whereas virtualised functions that are less demanding in terms of latency but handle large volumes of data are rather instantiated in centralised data centres, which are generally larger in size. The MEC (Mobile Edge Computing) initiative, consisting in instantiating application functions at the network edge, which can then be virtualised, should also be mentioned.

The instantiation of virtualised functions in data centres, whether centralised or distributed, requires computing, storage, memory, communication and energy resources. Similarly, the smooth operation of virtualised functions requires that these resources do not fail due to an interruption in the electrical power supply.

While centralised data centres can be supplied with power by several different electricity distribution networks, this is more difficult for distributed data centres, which due to their smaller size and their geographical location can only be supplied with power by a single non-redundant electricity distribution network.

To guard against failures impacting the electricity distribution network, data centres are equipped with an uninterruptible electrical power supply whose capacity may be sufficient to allow time to migrate the virtualised functions that cannot withstand interruptions to servers of an alternative data centre that does not suffer from a failure of the electricity distribution network.

This migration solution in response to a failure of the electricity distribution network assumes, however, that at least one alternative data centre compliant with the low latency requirements of some of the virtualised functions to be migrated, is supplied with electricity for a sufficient duration and has free and operational servers.

In addition, during the maintenance operations of a data centre, all or some of the servers hosted in this data centre can be rendered inoperative, independently of the events that may occur on the electricity distribution network supplying the data centre with power.

In order to ensure that the resources needed to protect virtualised functions are reserved efficiently, it is known to implement multisite protection schemes for virtualised functions, particularly when there is a proven risk of electrical power supply failure of a data centre.

To do this, it is proposed to reserve resources in virtualisation nodes deployed in servers hosted in data centres supplied with electricity by distinct electricity distribution networks.

Such a solution does not offer truly guaranteed protection because it does not take into account the occurrence of maintenance operations in the electricity distribution network and its impact on the instantiation and protection of virtualised functions executed within servers hosted in data centres affected by these maintenance operations in the electricity distribution network.

The present invention aims to resolve some or all of the above-mentioned disadvantages.

### SUMMARY OF THE INVENTION

The invention meets this need by proposing a method for managing a distributed architecture of data centres hosting a plurality of servers within which at least one virtualisation node is intended to be deployed.

Such a method is particular in that it is implemented by an item of management equipment of said distributed architecture and that it comprises the following steps:
obtaining data relating to a maintenance operation involving at least one first item of equipment of an electricity distribution network supplying a first data centre of said distributed architecture with power, said data comprising at least one maintenance duration of said first item of equipment,
when the maintenance duration of the first item of equipment is longer than or equal to an autonomy duration of at least one first item of electrical equipment locally supplying said first data centre with power, transmitting, to an entity for the deployment of the virtualisation nodes within the distributed architecture, a first list comprising at least one identifier of at least one second item of equipment of the electricity distribution network supplying said first data centre with power, having a maintenance duration that is shorter than or equal to the autonomy duration of the first item of electrical equipment.

Such a method ensures that the occurrence of a maintenance operation of an electricity distribution network does not have a negative impact on the execution of critical virtualised functions.

More specifically, such a solution makes it possible to anticipate the deployment of virtualisation nodes according to a maintenance schedule of equipment of electricity distribution networks supplying the various sites housing the data centres of a single distributed architecture with power. Thus, the virtualised functions executed by a virtualisation node hosted in a server, or a virtual machine, involved in a maintenance operation of the electricity distribution network that are particularly sensitive can be either migrated or duplicated in advance to servers for which the electrical power supply is guaranteed. Deploying a virtualisation node in advance guarantees the reservation of resources.

In some cases, the migration of the virtualised function has a significant impact on the quality of the service required. It is therefore preferable to trigger such a migration only when a failure of the item of equipment supplying the server with electrical power occurs.

In other cases, it is preferable to duplicate the virtualised function as soon as the second virtualisation node is created and migrate the service client to the second virtualised function when the failure of the item of equipment supplying the server with electrical power occurs.

Such a solution also makes it possible to manage servers in a rational way, because knowing the schedule of the maintenance operations that must occur on an electricity distribution network enables only the resources needed to be reserved for a duration adjusted to the needs. This optimises the management of the various pools of servers belonging to the same distributed architecture, and avoids reserving resources unnecessarily or for too long periods within one or more servers.

The implementation of such a solution is based on obtaining, by an item of management equipment of a distributed architecture, information relating to maintenance operations involving the electricity distribution networks supplying the various data centres of a single distributed architecture with power. Such an item of management equipment centralises information such as the identity and geographical location of the server(s) on which the virtualisation nodes are deployed, but also the requirements in terms of computing, storage, memory, communication and energy resources, but also information relating to an unavailability duration of certain equipment of the electricity distribution network supplying the servers of the data centres of the distributed architecture with power.

Armed with this various information, the item of management equipment is capable of anticipating the deployment of virtualisation nodes to which migrate the execution of virtualised functions in anticipation of an interruption of the electrical power supply of the servers on which these virtualised functions are being executed, in order to offer continuity of service.

Such a method can further comprise, when said first list is empty, the following steps:
receiving, from said deployment entity, a request for identification of at least one server hosted in a second data centre of said distributed architecture supplied with power by at least one third item of equipment of the electricity distribution network distinct from the first item of equipment and the second item of equipment,
transmitting, to said deployment entity, an identifier of said at least one server and a second list comprising at least one identifier of said at least one third item of equipment having a maintenance duration that is shorter than or equal to an autonomy duration of said at least one second item of electrical equipment locally supplying said second data centre with power.

When it is informed that no local item of electrical equipment is capable of providing the level of electrical power required for the execution of certain virtualised functions, the deployment entity queries the item of management equipment in order to obtain information about other servers having the resources needed to deploy a virtualisation node for the execution of the virtualised functions that must be migrated.

According to a particularity of the method covered by the invention, the step of obtaining the data relating to the maintenance operation involving the first item of equipment consists in receiving a message sent by a control module of said first data centre comprising at least one identifier of the first item of equipment and the maintenance duration of said first item of equipment.

Such a control module of a data centre is an item of equipment capable of communicating with equipment of the electricity distribution network(s) supplying the data centre it controls with power. Thus, the control module collects information relating to the electricity distribution network, in particular information relating to the maintenance operations, and transmits it to the item of management equipment.

In one example, the message transmitted by the control module further comprises an autonomy duration of said at least one first item of electrical equipment locally supplying said first data centre with power.

The transmission of the message by the control module is triggered by the reception, from said deployment entity, of a request for information relating to said maintenance operation involving said first item of equipment.

The entity for the deployment of virtualisation nodes can query the item of management equipment on a regular basis or as required, for example when reserving resources from a server, in anticipation of the deployment of virtualisation nodes to execute virtualised functions.

The message sent by the control module of said first data centre is transmitted repeatedly over time.

Such a message can be sent periodically or each time a new maintenance operation is scheduled.

The invention also relates to a method for protecting at least one first server within which at least one virtualisation node is intended to be deployed, said first server being hosted in a first data centre of a distributed architecture of data centres, said first data centre being supplied with power by at least one first item of equipment of an electricity distribution network involved in a maintenance operation.

Such a method for protecting at least one first server is implemented by an entity for the deployment of the virtualisation nodes within said distributed architecture and is particular in that it comprises the following steps implemented when a maintenance duration of the first item of equipment is longer than or equal to an autonomy duration of said one first item of electrical equipment:
receiving, from an item of management equipment of said distributed architecture, a first list comprising at least one identifier of at least one second item of equipment of the electricity distribution network supplying said first data centre with power, having a maintenance duration that is shorter than or equal to the autonomy duration of said first item of electrical equipment,
deploying said at least one virtualisation node within said first server.

When deploying a virtualisation node, the deployment entity can mark it with a label containing the identifiers of the equipment of the electricity distribution network contained in the list provided by the item of management equipment so that it is taken into account when executing the virtualised functions.

The method for protecting at least one first server can further comprise, when said first list is empty, the following steps:
sending, to said item of management equipment, a request for identification of at least one second server hosted in a second data centre of said distributed architecture supplied with power by at least one third item of equipment of the electricity distribution network distinct from the first item of equipment and the second item of equipment,
receiving, from said item of management equipment, an identifier of said second server and a second list comprising at least one identifier of said at least one third item of equipment having a maintenance duration that is shorter than or equal to an autonomy duration of at least one second item of electrical equipment locally supplying said second data centre with power.

By reserving the resources needed on a second server independent of ongoing maintenance operations on the electricity distribution network, the entity for the deployment of virtualisation nodes can deploy a new virtualisation node to ensure the migration of virtualised functions if a failure effectively occurs during the maintenance of the electricity distribution network on which the first server depends.

As with the first virtualisation node, the deployment entity can mark the new virtualisation node with a label containing item of equipment identifiers of the electricity distribution network different from the label of the first virtualisation node. In this way, the virtualised functions can be duplicated if necessary on two virtualisation nodes that do not depend on the same equipment of the electricity distribution network.

Another object of the invention relates to an item of management equipment of a distributed architecture of data centres hosting a plurality of servers within which at least one virtualisation node is intended to be deployed, said item of management equipment comprising at least one processor configured to:
obtain data relating to a maintenance operation involving at least one first item of equipment of an electricity distribution network supplying a first data centre of said distributed architecture with power, said data comprising at least one maintenance duration of said first item of equipment,
when the maintenance duration of the first item of equipment is longer than or equal to an autonomy duration of at least one first item of electrical equipment locally supplying said first data centre with power, transmit, to an entity for the deployment of the virtualisation nodes within the distributed architecture, a first list comprising at least one identifier of at least one second item of equipment of the electricity distribution network supplying said first data centre with power, having a maintenance duration that is shorter than or equal to the autonomy duration of the first item of electrical equipment.

The invention also relates to an entity for the deployment of the virtualisation nodes within a distributed architecture, said deployment entity being capable of protecting at least one first server within which at least one virtualisation node is intended to be deployed, said first server being hosted in a first data centre of the distributed architecture of data centres, said first data centre being supplied with power by at least one first item of equipment of an electricity distribution network involved in a maintenance operation, said deployment entity comprising at least one processor configured to:
receive, from an item of management equipment of said distributed architecture, a first list comprising at least one identifier of at least one second item of equipment of the electricity distribution network supplying said first data centre with power, having a maintenance duration that is shorter than or equal to the autonomy duration of said first item of electrical equipment, when a maintenance duration of the first item of equipment is longer than or equal to an autonomy duration of said one first item of electrical equipment,
deploy said at least one virtualisation node within said first server.

Finally, the invention relates to computer program products comprising program code instructions for implementing the methods as described previously, when they are executed by a processor.

The invention also relates to a computer-readable storage medium on which are saved computer programs comprising program code instructions for implementing the steps of the methods according to the invention as described above.

Such a storage medium can be any entity or device able to store the programs. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal that can be carried via an electrical or optical cable, by radio or by other means, so that the computer programs contained therein can be executed remotely. The programs according to the invention can be downloaded in particular on a network, for example the Internet network.

Alternatively, the storage medium can be an integrated circuit in which the programs are embedded, the circuit being adapted to execute or to be used in the execution of the above-mentioned methods that are the subject of the invention.

### LIST OF FIGURES

Other purposes, features and advantages of the invention will become more apparent upon reading the following description, hereby given to serve as an illustrative and non-restrictive example, in relation to the figures, among which:

FIG. 1: this figure shows a system in which the invention is implemented,

FIG. 2: this figure shows the various steps implemented by the various components of the system described with reference to FIG. 1 when implementing the various methods covered by the present invention.

### DETAILED DESCRIPTION OF EMBODIMENTS OF THE INVENTION

The general principle of the invention is based on the anticipation of the deployment of virtualisation nodes within servers hosted in data centres according to a maintenance schedule of equipment of electricity distribution networks supplying the various sites housing the data centres of a single distributed architecture with power. Thus, the virtualised functions executed by a virtualisation node hosted in a server involved in a maintenance operation of the electricity distribution network that are particularly sensitive can be either migrated or duplicated in advance to servers for which the electrical power supply is guaranteed. Deploying a virtualisation node in advance guarantees the reservation of resources.

The implementation of such a solution is based on obtaining, by an item of management equipment of a distributed architecture, information relating to maintenance operations involving the electricity distribution networks supplying the various data centres of a single distributed architecture with power. Such an item of management equipment centralises information such as the identity and geographical location of the server(s) on which the virtualisation nodes are deployed, but also the requirements in terms of computing, storage, memory, communication and energy resources, but also information relating to an unavailability duration of certain equipment of the electricity distribution network supplying the servers of the data centres of the distributed architecture with power.

Armed with this various information, the item of management equipment is then capable of anticipating the deployment of virtualisation nodes to which migrate the execution of virtualised functions in anticipation of an interruption of the electrical power supply of the servers on which these virtualised functions are being executed, in order to offer continuity of service.

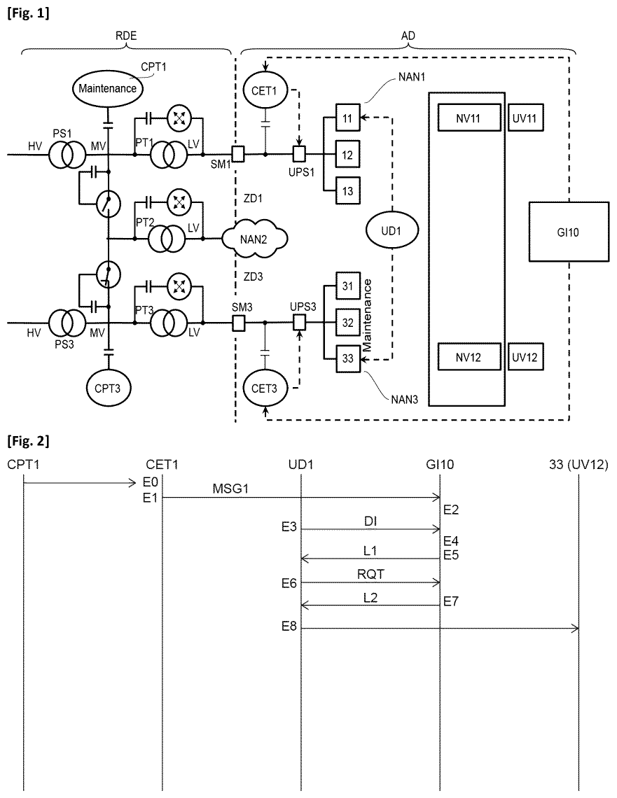

In the remainder of the description, an embodiment of the invention implemented in a system such as that shown in FIG. 1 is presented.

Such a system comprises, on the one hand, an electricity distribution network RDE and a distributed architecture of data centres AD.

The electricity distribution network RDE comprises several source stations PS1, PS3, transforming high-voltage electricity HV into medium-voltage electricity MV. Such source stations PS1, PS3 are controlled by source station controllers (not shown in the figure). The electricity distribution network RDE also comprises a plurality of transformer stations PT1, PT2, PT3, transforming medium-voltage electricity MV into low-voltage electricity LV intended to supply the neighbouring distribution networks NAN1, NAN2, NAN3 with power.

The transformer stations PT1, PT2, PT3 are controlled by transformer station controllers CPT1, CPT2 (not shown in FIG. 1) and CPT3. The electricity distribution network RDE further comprises signalling routing members (not shown in FIG. 1) for routing signalling messages between portions of the electricity distribution network RDE having different voltages, and smart counting units SM1, SM2 (not shown in FIG. 1) and SM3, dividing between the electricity distribution network RDE and the distributed architecture AD supplied with power by the electricity distribution network RDE.

The distributed architecture AD comprises several data centres DC1, DC3 (not shown in the figure), each data centre DC1, DC3 being located in availability zones ZD1, ZD3 which may or may not be co-located. The data centre DC1 comprises a plurality of computer servers 11, 12, 13 within which virtualisation nodes NV11, NV12 can be deployed, as well as at least one “uninterruptible” item of electrical equipment UPS1 supplying the computer servers 11, 12, 13 with power. The data centre DC2 also comprises a plurality of computer servers 31, 32, 33 within which virtualisation nodes NV11, NV12 can be deployed, as well as at least one uninterruptible item of electrical equipment UPS3 supplying the computer servers 31, 32, 33 with power. Virtualisation nodes NV11 and NV12 comprise a virtualisation unit UV11 and UV12 respectively. Of course, a server 11, 12, 13, 31, 32, 33 can simultaneously deploy several virtualisation nodes and a single virtualisation node can comprise a plurality of virtualisation units.

The electrical equipment UPS1 and UPS3 are controlled by a technical environment controller CET1 and by a technical environment controller CET3 respectively. Such technical environment controllers CET1, CET3 exchange service messages with the transformer station controllers CPT1, CPT2, CPT3 of the electricity distribution network RDE. Technical environment controllers CET1, CET3 also exchange service messages with an infrastructure manager (or item of management equipment) GI10 in charge of allocating and administering computer servers 11, 12, 13, 31, 32, 33.

Finally, the distributed architecture AD comprises at least one deployment unit UD1, in charge of deploying the virtualisation nodes NV11, NV12 within computer servers 11, 12, 13, 31, 32, 33. In order to deploy the virtualisation nodes NV11, NV12, the deployment unit UD1 exchanges service messages with the infrastructure manager GI10.

In relation to FIG. 2, the various steps implemented by the various components of the system described with reference to FIG. 1 when implementing the various methods covered by the present invention are presented.

The context of implementation of the methods covered by the present invention is that of a scheduled maintenance operation of the transformer station controller CPT1, which prohibits any remote intervention on the transformer station PT1 for the duration of the maintenance.

In the embodiment considered, no virtualisation node is deployed in the computer servers 31, 32, 33 of the data centre DC3 and a maintenance operation is in progress on the computer servers 31, 32 of the data centre DC3, preventing them from being used for several hours.

During the maintenance of the transformer station controller CPT1, a failure impacts the transformer station PT1, which in turn interrupts the distribution of electricity to the item of electrical equipment UPS1.

This interruption in electricity supply is detected by the technical environment controller CET1 in a step EO.

In a first implementation, the transformer station controller CPT1 transmits a message to the technical environment controller CET1 using known techniques such as carrier powerline communications or CPL. This message comprises in particular an estimated maintenance duration MTTR1 for the transformer station PT1 as well as an identifier of the transformer station PT1, noted IDPT1.

In a second implementation, this message is relayed by the smart counting unit SM1 to the technical environment controller CET1. In this implementation, the message can be transmitted using powerline communications to the item of electrical equipment UPS1, or via a direct interface, such as an Ethernet interface directly connected to the technical environment controller CET1.

After obtaining this information relating to the maintenance of the technical environment controller CET1, the technical environment controller CET1 generates and sends, during a step E1, a message MSG1 to the infrastructure manager GI10. Such a message MSG1 can comprise, among other things, an estimated maintenance duration MTTR1 of the transformer station PT1 as well as an identifier of the transformer station PT1, noted IDPT1. Such a message MSG1 further comprises an estimated autonomy duration MTBF1 of the item of electrical equipment UPS1. The message MSG1 can also comprise an identifier of the item of electrical equipment UPS1 as well as information relating to the availability zone ZD1 associated with the data centre DC1.

Upon receipt of the message MSG1, the infrastructure manager GI10 updates, in a step E2, a first reference file stored in one of its memories. This first file indicates that the computer servers 11, 12, 13 hosted in the data centre DC1 corresponding to the availability zone ZD1 are dependent, for their power supply, on the transformer station PT1 identified as IDPT1. The first file also indicates the estimated maintenance duration MTTR1 of the transformer station PT1.

The infrastructure manager GI10 also stores in the first reference file that the item of electrical equipment UPS1 on which the computer servers 11, 12, 13 depend has an estimated autonomy duration MTBF1 during which the item of electrical equipment UPS1 is capable of supplying the computer servers 11, 12, 13 with electrical power.

During a step E3, the deployment unit UD1 of the virtualisation node NV11 transmits a request for information DI relating to a maintenance operation to the infrastructure manager GI10.

In a particular implementation, the request for information DI comprises an identifier of the computer server 11 as well as a request to obtain the estimated autonomy duration of the item of electrical equipment UPS1.

In another implementation, the request for information DI also comprises a request to obtain the identifiers IDPT of transformer stations PT on which the computer server 11 depends and whose estimated maintenance durations MTTR are shorter than the autonomy duration of the item of electrical equipment UPS1.

Step E3 can, for example, be implemented periodically or each time the deployment unit UD1 is about to deploy one or more virtualisation nodes NV.

In response to the request for information DI, the item of management equipment GI10 identifies in the first reference file the identifier(s) IDPT of the transformer stations PT on which the computer server 11 depends and whose estimated maintenance durations MTTR are shorter than the autonomy duration of the item of electrical equipment UPS1, during a step E4.

When the item of management equipment GI10 has identified at least one transformer station PT on which the computer server 11 depends and whose estimated maintenance duration MTTR is shorter than the autonomy duration of the item of electrical equipment UPS1, it transmits, to the deployment entity UD1, a first list L1 comprising the identifier of this transformer station PT in a step E5.

When the item of management equipment GI10 has not identified any transformer station PT whose estimated maintenance duration MTTR is shorter than the autonomy duration of the item of electrical equipment UPS1, the first list L1 it transmits to the deployment entity UD1 is an empty list.

Upon receipt of an empty list L1, the deployment unit UD1 sends, in a step E6, a request for identification RQT of at least one server hosted in a data centre DC supplied with power by a transformer station distinct from the one(s) supplying the data centre DC1 with power. Such a request RQT comprises in particular the estimated autonomy duration MTBF1 of the transformer station PT1. The request RQT can also comprise information relating to the computing, storage, memory and communication resources required by the various virtualised functions executed by the virtualisation node NV11 deployed on the computer server 11.

In response to receiving the request ROT, the item of management equipment GI10 transmits an identifier of at least one server 33 hosted in the second data centre DC3 associated with the availability zone ZD3 and a second list L2 to the deployment unit UD1 in a step E7. This second list L2 comprises at least one identifier IDPT of at least one transformer station PT distinct from the transformer station PT1 having a maintenance duration MTTR that is shorter than or equal to an estimated autonomy duration MTBF of at least one item of electrical equipment UPS3 locally supplying the data centre DC3 with power. When the item of management equipment GI10 has received information relating to the computing, storage, memory and communication resources required, it uses it to identify one or more computer servers having such resources.

Upon receipt of the list L2, the deployment unit UD1 has all the information enabling it to deploy the virtualisation node NV12 within the server 33 identified in the list L2, in a step E8.

Thus, the virtualised functions executed by the virtualisation node NV11 hosted in the server 11 involved in a maintenance operation of the electricity distribution network RDE can be either migrated or duplicated in advance to the virtualisation node NV12 deployed for the occasion on the server 33.

Optionally, when the deployment unit UD1 deploys the virtualisation node UV12 on the server 33, it marks it by means of an availability zone label LBLZD3 comprising the identifiers IDPT of the transformer stations PT on which the computer server 33 depends for its electricity supply and whose maintenance durations MTTR are shorter than the autonomy duration of the item of electrical equipment UPS3 locally supplying the computer server 33 with power.

Such labels LBLZD make it easier to deploy virtualisation units UV. Indeed, when migrating or duplicating a virtualised function whose description file contains a request to create at least two virtualisation units UV11 and UV12 as well as an anti-affinity rule indicating that each virtualisation unit UV11 and UV12 must be deployed in virtualisation nodes hosted on computer servers located in different deployment zones, the existence of these labels LBLZD associated with each server belonging to the distributed architecture AD enables the appropriate computer server(s) to be identified quickly and with certainty. Thus, the virtualisation unit UV12 is created in the virtualisation node NV12 deployed on the second availability zone ZD3 independent of any failure of the transformer station PT1, which is not the case for the virtualisation node NV11, which although supplied with electricity by the item of electrical equipment UPS1, is impacted by this failure of the transformer station PT1 since the autonomy duration of the item of electrical equipment UPS1 is shorter than the maintenance duration MTTR1 of the transformer station PT1.

In this way, the risk that the two virtualisation nodes NV11 and NV12, each hosting a virtualisation unit UV11, UV12 involved in the execution of the virtualised function, fail at the same time is reduced, thus offering increased availability of the service provided by the virtualised function.

When the controller CPT1 is put back into service at the end of the maintenance period, the transformer station controller CPT1 sends a new message to the technical environment controller CET1. This new message comprises a new estimated maintenance duration MTTR1′ of the transformer station. When the new estimated maintenance duration MTTR1′ is shorter than or equal to the autonomy duration MTBF1, the deployment unit UD1 removes the virtualisation node NV12. The server 33 being thus released, the item of management equipment GI10 can then perform a maintenance operation on the latter.

1. A method for managing a plurality of data centres suitable for hosting at least one virtualisation node, said method being implemented by an item of management equipment of said plurality of data centres and comprising:
obtaining data relating to a maintenance operation involving at least one first item of equipment supplying a first data centres of said plurality of data centres with power, said data comprising at least one maintenance duration of said first item of equipment; and
in response to the maintenance duration of the first item of equipment being longer than or equal to an autonomy duration of at least one first item of electrical equipment locally supplying said first data centre with power, transmitting, to an entity for the deployment of virtualisation nodes within the plurality of data centres, a first list comprising at least one identifier of at least one second item of equipment supplying said first data centre with power, having a maintenance duration that is shorter than or equal to the autonomy duration of the first item of electrical equipment.

2. The method for managing a plurality of data centres according to claim 1, further comprising, when said first list is empty, the following steps:
receiving, from said deployment entity, a request for identification of at least one server hosted in a second data centre of said plurality of data centres supplied with power by at least one third item of equipment distinct from the first item of equipment and the second item of equipment; and
transmitting, to said deployment entity, an identifier of said at least one server and a second list comprising at least one identifier of said at least one third item of equipment having a maintenance duration that is shorter than or equal to an autonomy duration of said at least one second item of electrical equipment locally supplying said second data centre with power.

3. The method for managing a plurality of data centres according to claim 1, wherein the obtaining the data relating to the maintenance operation involving the first item of equipment comprises receiving a message sent by a control module of said first data centre comprising at least one identifier of the first item of equipment and the maintenance duration of said first item of equipment.

4. The method for managing a plurality of data centres according to claim 3, wherein said message further comprises an autonomy duration of said at least one first item of electrical equipment locally supplying said first data centre with power.

5. The method for managing a plurality of data centres according to claim 1, wherein said transmitting is triggered by a reception, from said deployment entity, of a request for information relating to said maintenance operation involving said first item of equipment.

6. The method for managing a plurality of data centres according to claim 3, wherein said message sent by the control module of said first data centre is transmitted repeatedly over time.

7. A method for protecting at least one first server within which at least one virtualisation node is intended to be deployed, said first server being hosted in a first data centre of a plurality of data centres, said first data centre being supplied with power by at least one first item of equipment involved in a maintenance operation, said method being implemented by an entity for the deployment of the virtualisation nodes within said plurality of data centres and comprising the following, which are implemented in response to a maintenance duration of the first item of equipment being longer than or equal to an autonomy duration of said one first item of electrical equipment:
receiving, from an item of management equipment of said plurality of data centres, a first list comprising at least one identifier of at least one second item of equipment supplying said first data centre with power, having a maintenance duration that is shorter than or equal to the autonomy duration of said first item of electrical equipment; and
deploying said at least one virtualisation node within said first server.

8. The method for protecting at least one first server according to claim 7, further comprising, when said first list is empty, the following steps:
sending, to said item of management equipment, a request for identification of at least one second server hosted in a second data centre of said plurality of data centres supplied with power by at least one third item of equipment distinct from the first item of equipment and the second item of equipment,
receiving, from said item of management equipment, an identifier of said second server and a second list comprising at least one identifier of said at least one third item of equipment having a maintenance duration that is shorter than or equal to an autonomy duration of at least one second item of electrical equipment locally supplying said second data centre with power.

9. An item of management equipment of a plurality of data centres suitable for hosting at least one virtualisation node, said item of management equipment comprising:
at least one processor configured to:
obtain data relating to a maintenance operation involving at least one first item of equipment of supplying a first data centre of said plurality of data centres with power, said data comprising at least one maintenance duration of said first item of equipment; and
in response to the maintenance duration of the first item of equipment being longer than or equal to an autonomy duration of at least one first item of electrical equipment locally supplying said first data centre with power, transmit, to an entity for the deployment of the virtualisation nodes within the plurality of data centres, a first list comprising at least one identifier of at least one second item of equipment supplying said first data centre with power, having a maintenance duration that is shorter than or equal to the autonomy duration of the first item of electrical equipment.

10. An entity for the deployment of the virtualisation nodes within a plurality of data centres, said deployment entity being capable of protecting at least one first server within which at least one virtualisation node is intended to be deployed, said first server being hosted in a first data centre of the plurality of data centres, said first data centre being supplied with power by at least one first item of equipment involved in a maintenance operation, said deployment entity comprising:
at least one processor configured to:
receive, from an item of management equipment of said plurality of data centres, a first list comprising at least one identifier of at least one second item of equipment supplying said first data centre with power, having a maintenance duration that is shorter than or equal to the autonomy duration of said first item of electrical equipment, in response to a maintenance duration of the first item of equipment being longer than or equal to an autonomy duration of said one first item of electrical equipment; and
deploy said at least one virtualisation node within said first server.

11. A non-transitory computer readable medium comprising a computer program product stored thereon and comprising program code instructions for implementing the method for managing a plurality of data centres according to claim 1 when the instructions are executed by a processor of the item of management equipment.

12. A non-transitory computer readable medium comprising a computer program product stored thereon and comprising program code instructions for implementing the method for protecting the at least one first server according to claim 7, when the instructions are executed by a processor of the entity for the deployment of the virtualisation nodes.
